(19) United States
(12) Patent Application Publication
(10) Pub. No.: US 2022/0065276 A1
(43) Pub. Date: Mar. 3, 2022

(54) CONNECTOR FOR A MODULAR STRUCTURE

(71) Applicant: 2724889 ONTARIO INC., Oakville (CA)

(72) Inventors: Jacek STYRC, Oakville (CA); Sebastian LYSIAK, Bielsko-Biala (PL)

(21) Appl. No.: 17/477,770

(22) Filed: Sep. 17, 2021

Related U.S. Application Data
(62) Division of application No. 29/746,208, filed on Aug. 12, 2020, now Pat. No. D938068.

(51) Int. Cl. F16B 9/02

(52) U.S. Cl. CPC F16B 9/02

(57) ABSTRACT

A new, original and ornamental design for a connector for a modular structure.

This is an application for a new, original and ornamental design for a CONNECTOR FOR A MODULAR STRUCTURE of which the following is a specification, with reference being made to the accompanying drawings, which form a part thereof.

### DESCRIPTION OF FIGURES

The following is a brief description of the figures forming a part of the present specification:

FIG. 1 is a front perspective view of the CONNECTOR FOR A MODULAR STRUCTURE;

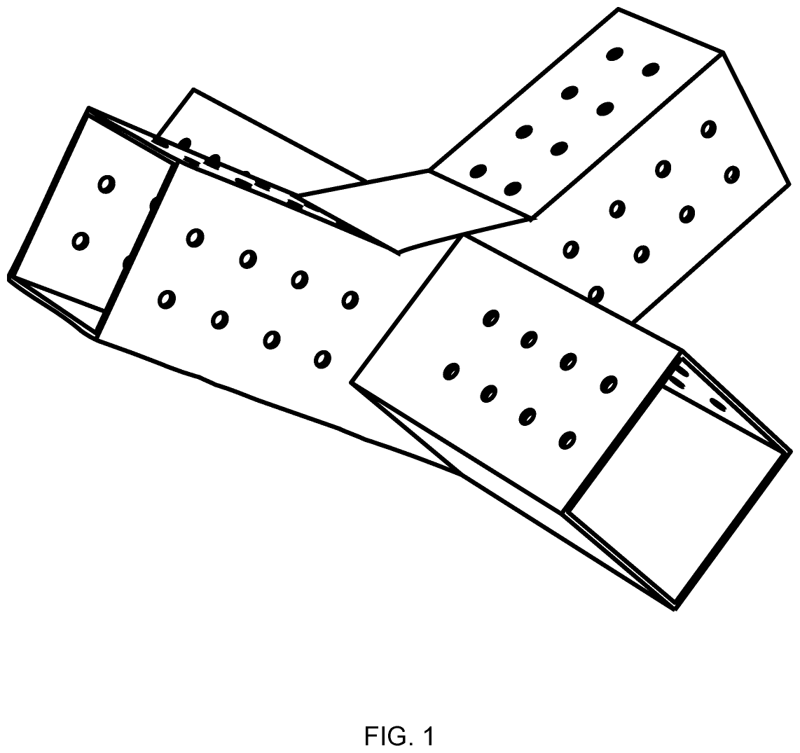

FIG. 2 is a plan view of the CONNECTOR FOR A MODULAR STRUCTURE of FIG. 1;

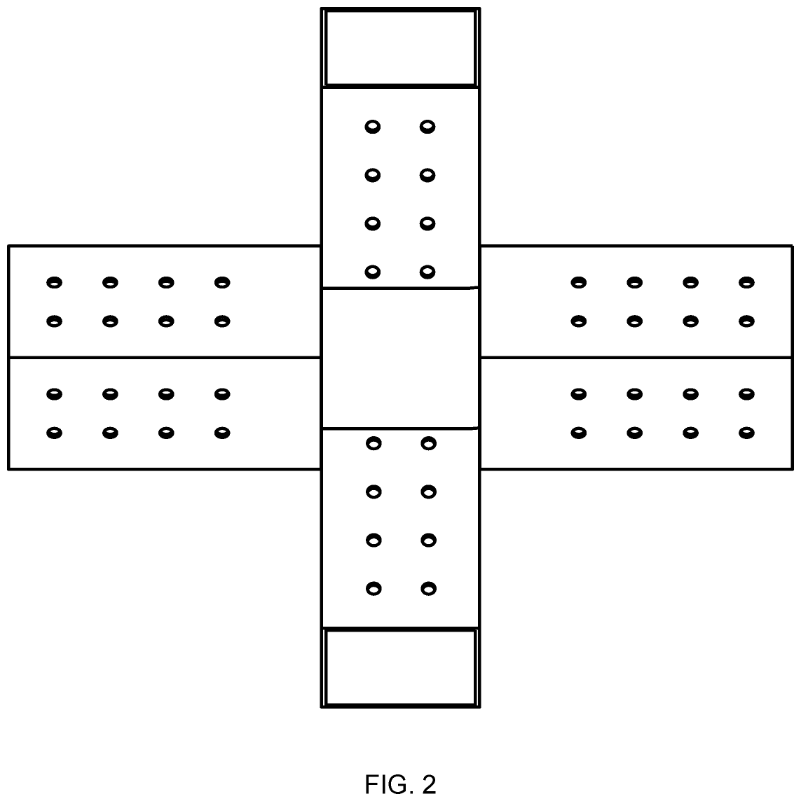

FIG. 3 is a bottom view of the CONNECTOR FOR A MODULAR STRUCTURE of FIG. 1;

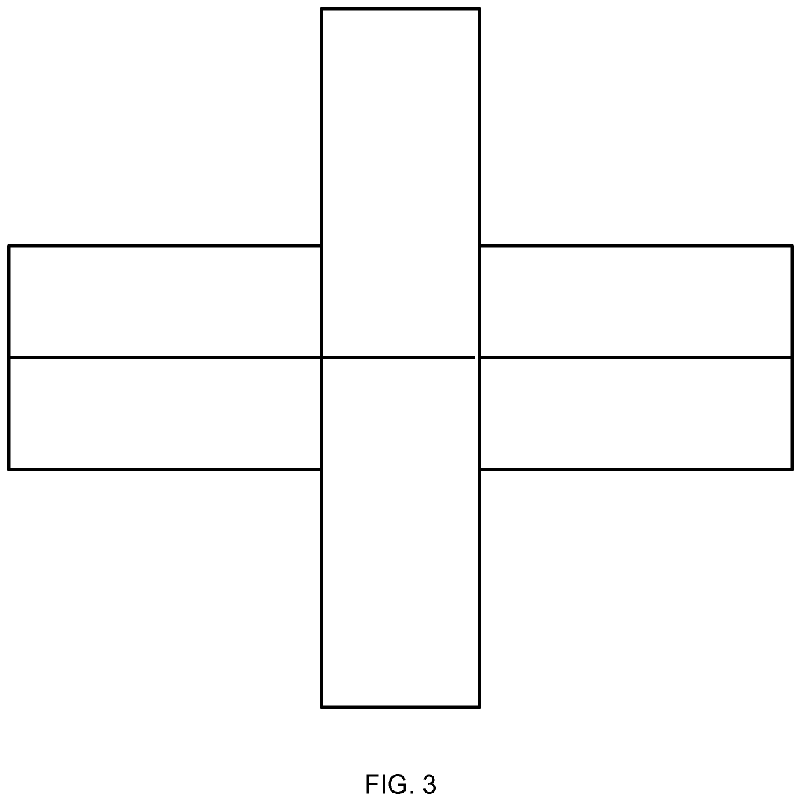

FIG. 4 is a front view of the CONNECTOR FOR A MODULAR STRUCTURE of FIG. 1;

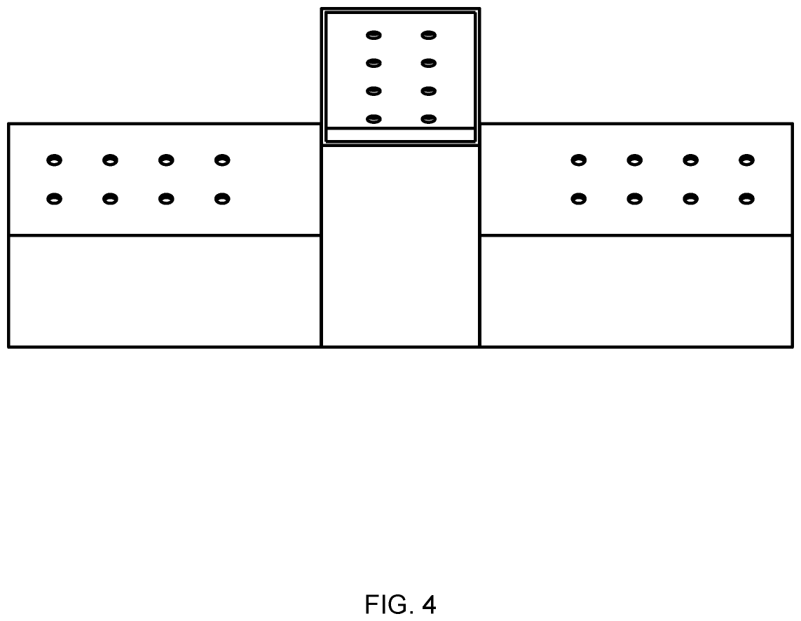

FIG. 5 is a back view of the CONNECTOR FORA MODULAR STRUCTURE of FIG. 1;

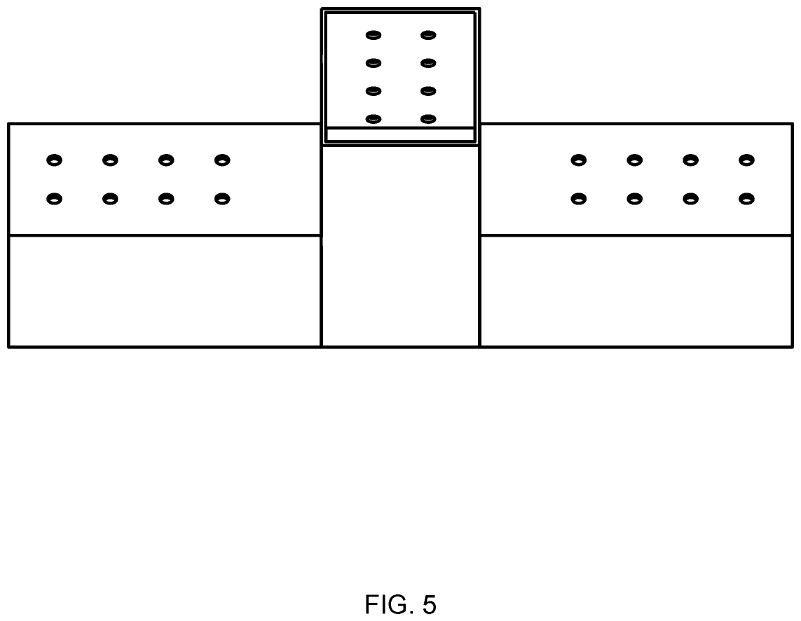

FIG. 6 is a side elevation of the CONNECTOR FOR A MODULAR STRUCTURE of FIG. 1;

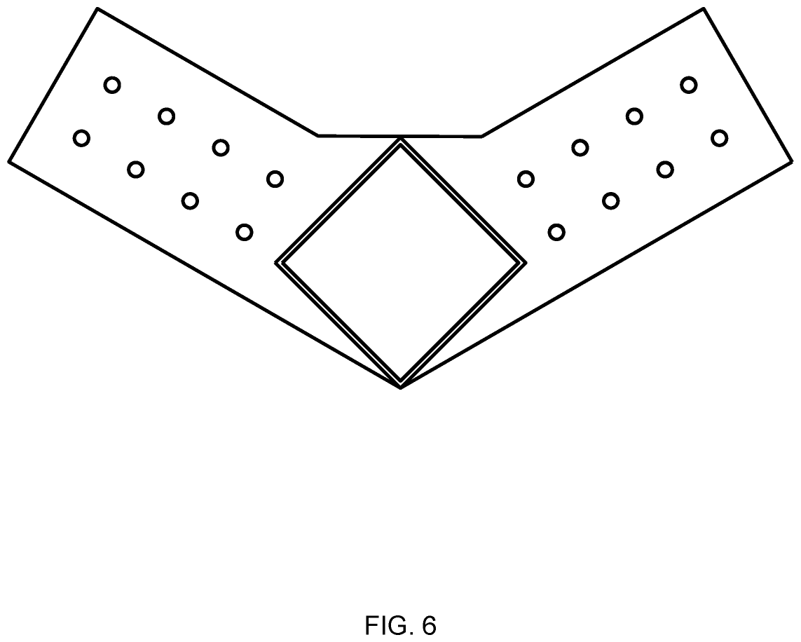

FIG. 7 is a side elevation from the opposite side to FIG. 6 of the CONNECTOR FOR A MODULAR STRUCTURE of FIG. 1;

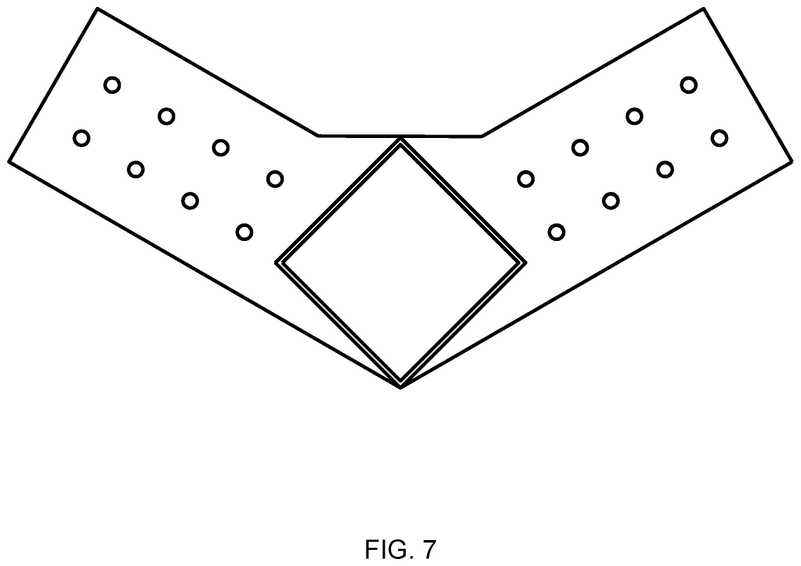

FIG. 8 is a rear perspective of the CONNECTOR FOR A MODULAR STRUCTURE of FIG. 1.

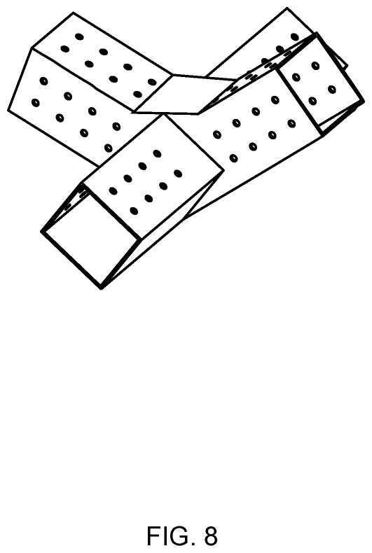

We claim:

1. The ornamental design for a CONNECTOR FOR A MODULAR STRUCTURE substantially as shown and described.
